(19) United States
(12) Patent Application Publication
(10) Pub. No.: US 2024/0368035 A1
(43) Pub. Date: Nov. 7, 2024

(54) IMPROVED WORKABILITY RETENTION IN LOW-CLINKER HYDRAULIC COMPOSITIONS

(71) Applicant: CHRYSO, Courbevoie (FR)

(72) Inventors: Laurent BONAFOUS, SEVRES (FR); Pascal BOUSTINGORRY, BREUILLET (FR)

(21) Appl. No.: 18/563,845

(22) PCT Filed: May 24, 2022
(86) PCT No.: PCT/EP2022/063991

§ 371 Date: Nov. 22, 2023

(30) Foreign Application Priority Data
May 26, 2021 (FR) FR2105469

(51) Int. Cl. C04B 24/02; C04B 24/12; C04B 28/06; C04B 28/08; C04B 28/26; C04B 103/30; C04B 103/40

(52) U.S. Cl. CPC C04B 24/02; C04B 24/122; C04B 28/06; C04B 28/08; C04B 28/26; C04B 2103/308; C04B 2103/408

(57) ABSTRACT

The present application concerns the use of a molecule producing an aqueous solution exhibiting a dispersive portion of more than 25%, for improving workability retention in a hydraulic composition based on a hydraulic binder composition including aluminosilicates and a maximum of 10% by weight of clinker preferably from 0 to 10% by weight of clinker.

### CROSS-REFERENCE TO RELATED APPLICATIONS

This application is the US national stage of PCT/EP2022/063991, filed May 24, 2022 and designating the United States, which claims the priority of FR FR2105469, filed May 26, 2021. The entire contents of each foregoing application are incorporated herein by reference.

### BACKGROUND OF THE INVENTION

### Field of the Invention

The present invention relates to hydraulic binder compositions comprising blast furnace slag or other aluminosiliceous source and a reduced amount of clinker, and to the retaining of the workability of the hydraulic composition obtained, in particular via the addition of water to said hydraulic binder composition.

### Description of the Related Art

Usual cement compositions comprise a variable and sometimes major proportion of clinker. For example, a cement composition according to standard NF EN 197-1 of 2012 comprises from 5 to 95% by weight of clinker.

However, the production of clinker requires the use of powerful furnaces generating the emission of large quantities of carbon dioxide. Extraction of the raw materials is also a source of carbon dioxide release.

It is therefore sought to lower the clinker content of cement compositions to reduce the carbon impact thereof, whilst maintaining their mechanical and rheological properties.

For this purpose, novel hydraulic binder compositions are being developed in which the quantity of clinker is reduced.

Cement compositions in which the hydraulic binder is a blast furnace slag have been described; the setting of these compositions is generally obtained through the addition of an alkaline source. However, there is a very rapid drop in the workability of these compositions, which means that they change from a fluid state to an almost solid state in less 30 minutes. From a rheological viewpoint, yield stresses are typically observed of 1 to 10 Pa five minutes after mixing, which increases up to 50 to 100 Pa between 30 and 60 minutes after mixing.

There would therefore be an advantage in providing a solution allowing improved fluidity of compositions of blast furnace slags or other aluminosiliceous sources.

### SUMMARY OF THE INVENTION

It is therefore one object of the present invention to provide a hydraulic binder composition from blast furnace slags or other aluminosiliceous sources allowing a hydraulic composition to be obtained having improved fluidity retention.

A further object of the invention is to provide said composition allowing the retaining of fluidity for 1 h or 1 h30.

Further objects will become apparent on reading the following description of the invention.

All these objects are met with the present invention which concerns the use of at least one molecule producing an aqueous solution exhibiting a dispersive portion of more than 25% for improving the workability retention of a hydraulic composition based on a hydraulic binder composition comprising at least one hydraulic binder comprising aluminosilicates and a maximum of 10% by weight of clinker, preferably from 0 to 10% by weight of clinker.

The hydraulic binder composition can be free of clinker.

Preferably, the binder comprising aluminosilicates is chosen from among blast furnace slags and/or other aluminosiliceous sources.

The present invention therefore preferably concerns the use of at least one molecule producing an aqueous solution exhibiting a dispersive portion of more than 25%, to improve the workability retention of a hydraulic composition based on a hydraulic binder composition comprising blast furnace slag and/or other aluminosiliceous sources, preferably blast furnace slag, and a maximum of 10% by weight of clinker, preferably from 0 to 10% by weight of clinker.

Blast furnace slag is defined in particular in parts 3.7 and 3.6 of standard NF EN 15167-1. Blast furnace slags are mostly glassy materials and are by-products of pig iron production. The blast furnace slags included in the hydraulic binder compositions are finely ground preferably down to a diameter of 100 à 150 μm at most, the diameter being measured with any method known to skilled persons, for example by laser particle size measurement. Blast furnace slags generally require calciferous or sulfo-calciferous activation, or the use of a strong base.

The other aluminosiliceous sources can belong to the family of pozzolanic materials (such as defined in cement standard NF EN 197-1 (2012) paragraph 5.2.3), fly ash (such as defined in cement standard NF EN 197-1 (2012) paragraph 5.2.4), burnt shale (such as defined in cement standard NF EN 197-1 (2012) paragraph 5.2.5), or silica fume (such as defined in cement standard NF EN 197-1 (2012) paragraph 5.2.7) or mixtures thereof. Other minerals currently not recognized by cement standard NF EN 197-1 (2012), can also be used. These are particularly metakaolins such as type A metakaolins conforming to standard NF P 18-513 (August 2012) or calcined clays, siliceous additions such as siliceous additions of Qz mineralogy conforming to standard NF P 18-509 (September 2012), aluminosilicates in particular of inorganic geopolymer type, aluminosilicates containing iron oxides such as bauxite residues, or norite or aplite from excavation work.

Preferably by aluminosiliceous compound it is meant fly ash (such as defined in cement standard NF EN 197-1 (2012) paragraph 5.2.4), metakaolins, such as type A metakaolins conforming to standard NF P 18-513 (August 2012), or calcined clays, aluminosilicates in particular of inorganic geopolymer type.

The composition of the invention may comprise a mixture of aluminosiliceous compounds.

Preferably, the hydraulic binder composition comprises from 75 to 99% by weight of aluminosiliceous compound, preferably from 80 to 95% by weight, for example from 80 to 90% by weight relative to the total weight of hydraulic binder.

The hydraulic binder composition can be free of clinker.

In the present invention, the clinker can be a clinker of Portland cement, sulfoaluminate or sulfobelitic cement.

Therefore, the hydraulic binder composition of the invention may also comprise an activator of blast furnace slag and/or other aluminosiliceous sources. These activators are known and are described in particular in: Alkaline activation of different aluminosilicates as an alternative to Portland cement: alkali activated cements or geopolymers. Revista Ingeniería de Construcción RICVol 32 N°22017. Preferably, a calciferous or sulfo-calciferous activator or an alkaline salt, preferably sodium or potassium carbonate, hydroxide, silicate, or mixtures thereof. This activator is used in proportions of from 0 to 20% by dry weight, preferably from 0 to 10% by dry weight relative to the weight of hydraulic binder, preferably from 0.1 to 20% by dry weight relative to the weight of hydraulic binder, preferably from 1% to 20% by dry weight relative to the weight of hydraulic binder.

The hydraulic binder composition may also comprise calcium sulfate, in particular in a proportion of 5 to 20% by weight. Said hydraulic binder compositions are also called super-sulfated cement (SSC) and in particular are such as defined in standard NF EN 15743+A1.

Preferably, the hydraulic binder composition consists in a blast furnace slag and/or other aluminosiliceous sources, and optionally an activator.

In one embodiment, the hydraulic binder consists in an aluminosiliceous compound and an alkaline or sulfate activator.

The hydraulic binder composition may also comprise mineral additions, preferably from 0 to 10% by weight relative to hydraulic binder weight.

The expression «mineral additions» designates pozzolanic materials (such as defined in cement standard NF EN 197-1 (2012) paragraph 5.2.3), fly ash (such as defined in cement standard NF EN 197-1 (2012) paragraph 5.2.4), burnt shale (such as defined in cement standard NF EN 197-1 (2012) paragraph 5.2.5), limestones (such as defined in cement standard NF EN 197-1 (2012) paragraph 5.2.6) or silica fume (such as defined in cement standard NF EN 197-1 (2012) paragraph 5.2.7) or mixtures thereof. Other additions not currently recognized by cement standard NF EN 197-1 (2012) can also be used. These particularly concern metakaolins, such as type A metakaolins conforming to standard NF P 18-513 (August 2012) or calcined clays, siliceous additions such as siliceous additions of Qz mineralogy conforming to standard NF P 18-509 (September 2012), aluminosilicates in particular of inorganic geopolymer type, aluminosilicates containing iron oxides such as bauxite residues, norite or aplite from excavation work. The proportions of additions and their type can also conform to provisional standard prEN 197-5, which defines CEM II/C-M cements comprising between 50 and 64% clinker and 36 to 50% blast furnace slag, and CEM VI cements comprising from 35 to 49% clinker, from 31 to 59% blast furnace slag and from 6 to 20% mineral additions such as defined above.

Preferably, the expression «mineral additions» designates pozzolanic materials (such as defined in cement standard NF EN 197-1 (2012) paragraph 5.2.3), burnt shale (such as defined in cement standard NF EN 197-1 (2012) paragraph 5.2.5), limestones (such as defined in cement standard NF EN 197-1 (2012) paragraph 5.2.6) or silica fume (such as defined in cement standard NF EN 197-1 (2012) paragraph 5.2.7), or mixtures thereof Other additions, not currently recognized by cement standard NF EN 197-1 (2012) can also be used These chiefly concern siliceous additions such as siliceous additions of Qz mineralogy conforming to standard NF P 18-509 (September 2012). The proportion of additions and their type can also conform to provisional standard prEN 197-5, which defines CEM II/C-M cements comprising between 50 and 64% clinker and from 36 to 50% blast furnace slag, and CEM VI cements comprising from 35 to 49% clinker, from 31 to 59% blast furnace slag and from 6 to 20% mineral additions such as defined above.

Therefore, in the present invention the hydraulic binder composition comprises blast furnace slag and/or other aluminosiliceous sources, optionally an activator such as defined above, optionally clinker of Portland cement, sulfoaluminate or sulfobelitic cement, and optionally mineral additions such as described above.

Preferably, the hydraulic binder of the invention comprises blast furnace slag.

In the present invention, by «total hydraulic binder weight», it is meant the weight of the binders comprising aluminosilicates, preferably blast furnace slag and/or other aluminosiliceous sources, the activator if any, clinker if any, and mineral additions if any.

In the present invention, the improvement in workability retention measured for example by changes over time in the yield stress of a hydraulic composition obtained from the hydraulic binder composition defined above, in particular through the addition of water, is preferably long-term improvement, namely over a time longer than or equal to 45 minutes, in particular longer than 60 minutes, even longer than 90 minutes when the composition is used at 20° C. It is therefore desired to obtain yield stresses in the region of 1 to 10 Pa for the same time intervals i.e. over a time longer than or equal to 45 minutes, in particular longer than 60 minutes, even longer than 90 minutes when the composition is used at 20° C.

The improvement in workability retention is determined relative to the same composition not containing said molecule.

Yield stress can particularly be measured with a rheometer by taking several measurements of applied stress to obtain each corresponding value of strain rate. The applied stress below which the strain rate becomes very low or zero can be considered to be the yield stress. Preferably, the yield stress obtained when implementing the present invention is lower than 130 Pa at 120 min, preferably of between 30 and 130 Pa at 120 min, and for example it is between 30 and 90 Pa at 120 min.

In the present invention, the dispersive portion of an aqueous solution of said molecule is determined by measuring the surface energy components of an aqueous solution comprising said molecule (SAM). For this purpose, the aqueous solution of said molecule (SAM) is deposited on a strip of poly(tetrafluoroethylene) (PTFE), placed on a glass slide. PTFE is a material having the particularity of not being polar and having a known purely dispersive surface energy σ_{S}^{D}=18 mJ/m2.

The molecules of any substance, solid or liquid, interact via two classes of forces: dispersive forces (due to transient electric dipoles: London-van der Waals . . . ) and polar forces (due to permanent electric dipoles). The surface energy of a liquid L and of a solid S can be broken down into the sum of each of their components:

$${σ}_{L} = {σ}_{L}^{D} + {σ}_{L}^{P} \qquad ( 2 )$$

$${σ}_{S} = {σ}_{S}^{D} + {σ}_{S}^{P} \qquad ( 3 )$$

With the Owens-Wendt model, the contact angle which will be formed by depositing a drop of L on a surface of S can be related to the polar and dispersive components of the surface energies of the two materials:

$$\frac{{σ}_{L} ( 1 + cos θ )}{2} = \sqrt{{σ}_{L}^{D} {σ}_{S}^{D}} + \sqrt{{σ}_{L}^{P} {σ}_{S}^{P}} \qquad ( 4 )$$

With the depositing of the aqueous solution of said molecule (SAM) on PTFE, the equation (4) then becomes:

$$\frac{{σ}_{L} ( 1 + cos θ )}{2} = \sqrt{{σ}_{L}^{D} \cdot 18} \qquad ( 5 )$$

It is then possible to infer the dispersive component of solution SAM by drop deposit, angle measurement and knowledge of surface tension by pendant drop analysis. The polar component of solution SAM is then inferred by the difference between the surface tension and the dispersive component.

The dispersive portion corresponds to the percentage of dispersive component relative to the sum of the dispersive component and polar component.

Preferably, the molecule of the invention allows the producing of an aqueous solution having a dispersive portion greater than that of water, preferably of between 25 and 50%, preferably between 25 and 45%, for example between 25 and 45%. In the present invention, by molecule allowing an aqueous solution to be produced having a greater dispersive portion than water, preferably of between 25 and 50% preferably between 25 and 45%, for example between 25 and 45%, it is meant a molecule which when mixed with water allows the obtaining of an aqueous solution (solution in water) having a dispersive portion greater than that of water, preferably of between 25 and 50%, preferably between 25 and 45%, for example between 25 and 45%.

Preferably, the molecule is used in water in a content allowing a water+molecule mixture to be obtained having a dispersive portion greater than that of water, preferably of between 25 and 50%, preferably between 25 and 45%, for example between 25 and 45%, preferably the content of molecule in water is between 1 and 5% by weight, preferably between 1 and 4% by weight relative to the total weight of the water+molecule solution.

Preferably, the molecule of the invention allows an aqueous solution to be produced (water+molecule solution) having a dispersive portion of between 12 mN/m and 35 mN/m, preferably between 14 and 32 mN/m.

Preferably, the molecule of the invention allows an aqueous solution to be produced (water+molecule solution) having a dispersive portion of between 12 mN/m and 35 mN/m, preferably between 14 and 32 mN/m, and a polar component of between 25 and 60 mN/m, preferably between 25 and 55 mN/m.

The molecule of the invention preferably comprises at least one OH function, preferably one, two, or three OH functions. Preferably the molecule of the invention is chosen from among alcohols and alkanolamines, for example 2-methyl-2,4 pentanediol, 2,2-dimethylpropane-1,3-diol, 2-methyl-1,3-propanediol, 5-ethyl-1,3-dioxane-5-methanol, tri(isopropanol)amine, preferably 2-methyl-2,4 pentanediol, 2-methyl-1,3-propanediol, 5-ethyl-1,3-dioxane-5-methanol, tri(isopropanol)amine.

Preferably, the molecule of the invention is used in contents of between 0.5 and 3% by weight, preferably between 1 and 2% by weight, relative to the total weight of hydraulic binder.

Preferably the molecule is added when mixing with water. Therefore, the invention concerns the use of an aqueous solution of a molecule (water+molecule solution) having a dispersive portion greater than that of water, preferably greater than 25%, preferably between 25 and 50%, preferably between 25 and 45%, for example between 25 and 45%.

Preferably, the aqueous solution of the molecule of which the dispersive portion is measured only comprises water and said molecule.

The molecule can optionally be added when grinding the hydraulic binder.

A guanidine salt can also be used to improve workability retention.

Other admixtures can be used in the present invention in addition to the above-mentioned molecules. These admixtures can be chosen by skilled persons from among typical admixtures for cement compositions and hydraulic compositions. Particular mention can be made of alkanolamines, salts such as sodium chloride, calcium chloride, sodium thiocyanate, calcium thiocyanate, sodium nitrate and calcium nitrate and mixtures thereof, glycols, glycerols, water-reducing and high range water-reducing admixtures, surfactants, carboxylic acids and salts thereof such as acetic, acetic, adipic, gluconic, formic, oxalic, citric, maleic, lactic, tartaric, malonic acids and mixtures thereof, defoaming additives, air-entraining additives and/or milling agents, set retarders.

In the present invention, among set retarders, particular mention can be made of sugar-, molasses- or vinasse-based set retarders.

Preferably, the water-reducing admixtures and high-range water reducers are chosen from among:
Sulfonated salts of naphthalene and formaldehyde polycondensates, commonly called polynaphthalene sulfonates or naphthalene superplasticizers;
Sulfonated salts of melamine and formaldehyde polycondensates, commonly called melamine superplasticizers;
Lignosulfonates;
Sodium gluconate and sodium glucoheptonate;
Polyacrylates;
Polyarylethers (PAEs);
Products based on polycarboxylic acids, in particular polycarboxylate comb copolymers which are branched polymers in which the main chain carries carboxylic groups and the side chains are composed of sequences of polyether type, in particular ethylene polyoxide such as poly [(meth)acrylic acid-graft-ethylene polyoxide]. Particular use can be made of the superplasticizers in the ranges CHRYSO®Fluid Optima, CHRYSO®Fluid Premia and CHRYSO®Plast Omega marketed by CHRYSO;
Products based on polyalkoxylated polyphosphonates, in particular those described in patent EP 0 663 892 (e.g. CHRYSO®Fluid Optima 100).

The hydraulic composition may also comprise other additives known to skilled persons, for example a mineral addition and/or additives such as an air-entraining additive, a defoaming agent, a set accelerator or retarder, a rheology-modifying agent, another fluidizer (plasticizer or superplasticizer), in particular a superplasticizer for example a CHRYSO®Fluid Premia 180 or CHRYSO®Fluid Premia 196 superplasticizer.

The present invention further concerns a method for improving the workability retention of a hydraulic composition based on a hydraulic binder composition comprising binders comprising aluminosilicates, for example blast furnace slag and/or other aluminosiliceous source, optionally an activator, no more than 10% clinker, preferably from 0 to 10% by weight of clinker, comprising the addition of at least one molecule allowing an aqueous solution to be obtained having a dispersive portion greater than that of water, preferably greater than 25%, preferably between 25 and 50%, preferably between 25 and 45%, for example between 25 and 45%, to said hydraulic composition.

In the present invention, the improvement in workability retention (or maintained fluidity) is considered in comparison with the same hydraulic composition not comprising the molecule of the invention.

The preferred and advantageous characteristics mentioned above for the molecule and hydraulic binder composition etc., also apply to the method of the invention.

The invention further concerns a hydraulic composition comprising (even consisting in) the hydraulic binder composition defined above, water, an aggregate and optionally one or more mineral additions, and at least one molecule allowing mixing water to be obtained having a dispersive portion greater than that of water preferably greater than 25%, preferably between 25 and 50%, preferably between 25 and 45%, for example between 25 and 45%.

The preferred and adventurous characteristics mentioned above for the molecule, the hydraulic binder composition etc., also apply to the hydraulic composition.

In the present invention, the hydraulic composition is preferably a concrete, mortar, or screed composition.

By «aggregates», it is meant an assembly of mineral grains having a mean diameter of between 0 et 125 mm. Depending on their diameter, the aggregates are classified in one of the six following families: fillers, fine sand, coarse sand, gravel sand, gravel, and ballast (standard XP P 18-545). The aggregates that are most used are the following:
fillers, having a diameter of less than 2 mm and for which at least 85% of the aggregate has a diameter of less than 1.25 mm, and at least 70% of the aggregate has a diameter of less than 0.063 mm,
sands having a diameter of between 0 et 4 mm (in standard 13-242, the diameter possibly reaching 6 mm),
gravel sand having a diameter greater than 6.3 mm,
gravel having a diameter of between 2 mm and 63 mm.

Sands are therefore included in the definition of aggregate according to the invention.

Fillers can be of lime or dolomitic origin in particular.

Other additives can also be added to the hydraulic composition (HC) of the invention, such as air-entraining additives, defoaming agents, set accelerators or retarders, rheology-modifying agent, another fluidizer (plasticizer or superplasticizer).

The hydraulic compositions are prepared as is conventional by mixing the above-mentioned constituents. The molecule of the invention is added at the time of mixing with water, or when grinding the hydraulic binder composition.

### DETAILED DESCRIPTION

The invention is illustrated in the following examples.

### Example 1: Protocol for Preparing the Hydraulic Binder Composition and Rheology Measurement

Mixing of the materials is carried out in the following manner:
1. The water and the molecule of the invention are weighed in a mixing bowl, the mixer is set in operation at a speed of 43 rpm.
2. The chronometer is started and the binder is poured in 30 seconds.
3. The speed is increased to 96 rpm and mixture is mixed for one minute.
4. The mixer is stopped for 30 seconds, and any material sprayed onto the side of the bowl is scraped towards the centre with a spatula.
5. The suspension is mixed for one minute at 96 rpm.

On completion of mixing, the paste obtained is poured into a cylindrical measuring cell of a Kinexus Pro (Netzsch) rheometer equipped with measuring geometry of vane type.

Five minutes after the start of mixing, the cement mixture is subjected to pre-shear for one minute at a strain rate of 200 s⁻¹. The sample is then subjected to a series of decreasing strain rate plateaux via logarithmic intervals of 200 s⁻¹ to 0.01 s⁻¹ and the rheometer records the stress to be applied at each point. The whole forms a flow curve relating the stress applied to obtain each value of strain rate.

These flow curves show a minimum stress which is interpreted as a yield stress i.e. a minimum stress to be applied to cause flow. This value varies inversely to fluidity, it is therefore sought to lower this value as much as is possible.

The flow curve is afterwards measured every 30 min up to 120 min after the start of mixing, to verify the changes in fluidity over time.

### Example 2: Measurement of Polar and Dispersive Components of the Molecules

Measurements of the polar and dispersive components of different solutions of molecules are grouped together in the following Table.

TABLE 1

| | Pure | Pure | | | | |
|---|---|---|---|---|---|---|
| | molecule/ | molecule/ | | Contact | | |
| | binder | binder | Surface | Angle | Dispersive | Polar |
| | dosage | dosage | tension | PTFE | component | component |
| Molecule | (wt. %) | (wt. %) | (mN/m) | (°) | (mN/m) | (mN/m) |
| Reference: | — | — | 77.7 | 123 | 17.4 | 60.3 |
| ultrapure water | | | | | | |
| 2-methyl-2,4 | 1.5 | 3.75 | 54.8 | 114 | 14.7 | 40.1 |
| pentanediol | | | | | | |
| 2,2- | 1.5 | 3.75 | 59.3 | 115 | 16.3 | 43.0 |
| dimethylpropane- | | | | | | |
| 1,3-diol | | | | | | |
| 2-methyl-1,3 | 1.5 | 3.75 | 69.7 | 118 | 19.0 | 50.7 |
| Propanediol | | | | | | |
| 5-Ethyl-1,3- | 1.5 | 3.75 | 60.6 | 107 | 25.5 | 35.1 |
| dioxane-5- | | | | | | |
| methanol | | | | | | |
| Poly(naphthalene | 1.5 | 3.75 | 70 | 120 | 17.0 | 53.0 |
| sulfonate) | | | | | | |
| (comparative) | | | | | | |
| Tri(isopropanol) | 1.5 | 3.75 | 56.0 | 100 | 29.7 | 26.3 |
| amine | | | | | | |
| Poly(PEG | 0.5 | 1.25 | 48.8 | 122 | 7.3 | 41.5 |
| carboxylate) | | | | | | |
| (comparative) | | | | | | |
| Glycerine | 1.5 | 3.75 | 74.0 | 130 | 9.7 | 64.3 |
| (comparative) | | | | | | |

### Example 3: Results

A hydraulic composition was prepared following the protocol in Example 1 and in accordance with the composition in Table 2 below.

TABLE 2

| Component | Mass (g) |
|---|---|
| Blast furnace slag | 176.4 |
| Sodium silicate | 33.6 |
| 0/0 Palvadeau sand, 315 mm | 190 |
| Mains water | 84 |

The rheological results are summarized by measuring yield stress at 120 min after the start of mixing, this measurement giving the capacity of the molecules to retain high fluidity (low yield stress) over this period. This measurement was related to the dispersive portion of the surface energy of the liquid, defined as the ratio between the dispersive component and surface tension.

The results are given in Table 3 below.

TABLE 3

| | Pure | | |
|---|---|---|---|
| | molecule/ | | Yield stress |
| | binder | Dispersive | at 120 min |
| Molecule | dosage (%) | portion | (Pa) |
| Reference | — | 22.4% | 238.4 |
| 2-methyl-2,4 pentanediol | 1.5 | 26.8% | 46.4 |
| (of the invention) | | | |
| 2,2-dimethylpropane-1,3-diol | 1.5 | 27.5% | 121.0 |
| (of the invention) | | | |
| 2-methyl-1,3 Propanediol | 1.5 | 27.2% | 69.1 |
| (of the invention) | | | |
| 5-Ethyl-1,3-dioxane-5-methanol | 1.5 | 42.1% | 79.4 |
| (of the invention) | | | |
| Poly(naphthalene sulfonate) | 1.5 | 24.3% | 210.0 |
| (comparative) | | | |
| Tri(isopropanol)amine | 1.5 | 37.6% | 78.0 |
| (of the invention) | | | |
| Poly(mPEG carboxylate) | 0.5 | 15.0% | 506.0 |
| (comparative) | | | |
| Glycerine (comparative) | 1.5 | 13.1% | 252.0 |

The results show that the molecules of the invention allow a reduction in yield stress at 120 min, and consequently allow an improvement in workability retention.

1-10. (canceled)

11. A method for improving the workability retention of a hydraulic composition based on a hydraulic binder composition comprising at least one hydraulic binder comprising aluminosilicates and a maximum of 10% by weight of clinker, comprising the addition of at least one molecule whose aqueous solution of said molecule presents a dispersive portion of more than 25%, to said hydraulic composition.

12. The method according to claim 11, wherein the aqueous solution of said molecule presents a dispersive portion of between 25 and 50%.

13. The method according to claim 11, wherein the aqueous solution of said molecule presents a dispersive component between 12 mN/m and 35 mN/m.

14. The method according to claim 11, wherein the molecule comprises at least one OH function.

15. The method according to claim 11, wherein the molecule comprises one, two, or three OH functions.

16. The method according to claim 11, wherein the molecule is chosen from among alcohols and alkanolamines.

17. The method according to claim 11, wherein the molecule is chosen from among 2-methyl-2,4 pentanediol, 2,2-dimethylpropane-1,3-diol, 2-methyl-1,3-propanediol, 5-ethyl-1,3-dioxane-5-methanol, tri(isopropanol)amine.

18. The method according to claim 11, wherein the molecule is used in contents of between 0.5 and 3% by weight relative to the total weight of hydraulic binder.

19. The method according to claim 11, wherein the hydraulic binder composition comprises a calciferous or sulfo-calciferous activator, or an alkaline salt or calcium sulfate.

20. The method according to claim 11, wherein the molecule is for obtaining a mixing water presenting a dispersive portion of more than 25%.

21. A hydraulic composition comprising a hydraulic binder composition comprising at least one hydraulic binder comprising aluminosilicates and a maximum of 10% by weight of clinker, an activator of blast furnace slag and/or other aluminosiliceous sources, water, an aggregate and optionally one or more mineral additions, and at least one molecule producing a mixing water having a dispersive portion of more than 25%.

22. The hydraulic composition according to claim 21 comprising from 0.5 to 3% by weight of molecule relative to the total weight of hydraulic binder.
